(19) United States
(12) Patent Application Publication
(10) Pub. No.: US 2017/0109367 A1
(43) Pub. Date: Apr. 20, 2017

(54) EARLY COMPRESSION RELATED PROCESSING WITH OFFLINE COMPRESSION

(71) Applicant: International Business Machines Corporation, Armonk, NY (US)

(72) Inventors: Mihail C. Constantinescu, San Jose, CA (US); Joseph S. Glider, Palo Alto, CA (US); Danny Harnik, Tel Mond (IL); Leo Luan, Saratoga, CA (US); Wayne A. Sawdon, San Jose, CA (US); Frank B. Schmuck, Campbell, CA (US)

(21) Appl. No.: 14/885,889

(22) Filed: Oct. 16, 2015

(51) Int. Cl. G06F 17/30

(52) U.S. Cl. CPC G06F 17/30153; G06F 17/30374

(57) ABSTRACT

A method for early compression related processing in a file system with offline compression. The method includes receiving a data file in a buffer. A processor detects that at least a portion of a data block of the data file resides in the buffer. A compressibility indication of the data block is determined based on performing at least one compressibility analysis operation on the data block. The compressibility indication of the data block is stored. A background compression task is performed on the data block based on: determining a compression decision for the data block based on the compressibility indication, and compressing the data block based on the compression decision.

### BACKGROUND

Embodiments of the invention relate to file data compression, in particular, for determining compressibility while file data resides in memory for efficient offline file data compression.

In a storage system with offline compression (e.g., a general parallel file system (GPFS)), data may be written to a storage disk, uncompressed at first, and then only compressed at a later stage through a background compression process (e.g., after the file data has “cooled down” after a period of time without being updated). The reason to employ such a mechanism are three fold: 1) avoiding a performance bottleneck that may be incurred by in-line compression; 2) letting data cool before compressing it, and thus avoiding potential decompression or recompression overheads during reading or updating of the data; and 3) letting all new data within one compression group (i.e., aggregated data blocks) to cool down before determining whether that group should be compressed. However, such offline/deferrer file compression has an additional performance cost (i.e., storage and memory bandwidth consumption, processing cycles, etc.) due to the need of reading file data back into memory for compression. This process is particularly wasteful for data blocks that are not compressible. Degraded system performance can result, and background compression tasks can take an unacceptable long time to complete.

### SUMMARY

Embodiments of the invention relate to determining compressibility while file data resides in memory for efficient offline file data compression. In one embodiment, a method includes receiving a data file in a buffer. A processor detects that at least a portion of a data block of the data file resides in the buffer. A compressibility indication of the data block is determined based on performing at least one compressibility analysis operation on the data block. The compressibility indication of the data block is stored. A background compression task is performed on the data block based on: determining a compression decision for the data block based on the compressibility indication, and compressing the data block based on the compression decision.

These and other features, aspects and advantages of the present invention will become understood with reference to the following description, appended claims and accompanying figures.

### BRIEF DESCRIPTION OF THE DRAWINGS

FIG. 1 depicts a cloud computing node, according to an embodiment;

FIG. 2 depicts a cloud computing environment, according to an embodiment;

FIG. 3 depicts a set of abstraction model layers, according to an embodiment;

FIG. 4 is a block diagram illustrating a processing system for early compressibility determination while file data resides in memory and offline file data compression, according to an embodiment;

FIG. 5 illustrates a block diagram for a process for determining compressibility while file data resides in memory and offline file data compression, according to one embodiment; and

FIG. 6 illustrates a block diagram for a process for offline compression, according to one embodiment.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

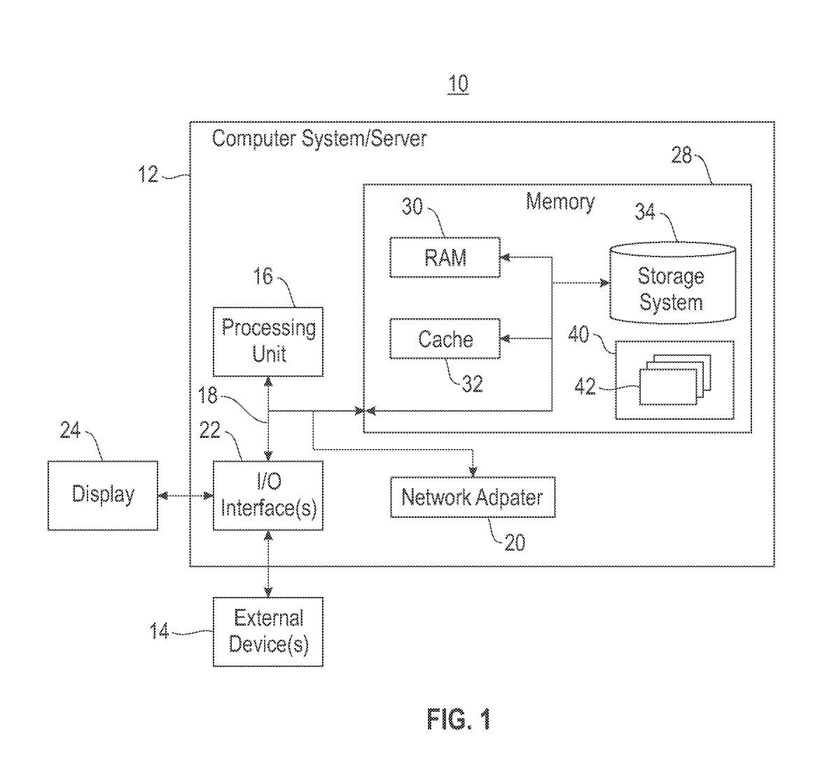

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 1, computer system/server 12 in cloud computing node 10 is shown in the form of a general purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example and not limitation, such architectures include a(n) Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile/non-volatile media, and removable/non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, a storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in a memory 28 by way of example and not limitation, as well as an operating system, one or more application programs, other program modules, and program data. Each of the operating systems, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14, such as a keyboard, a pointing device, etc.; a display 24; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks, such as a local area network (LAN), a general wide area network (WAN), and/or a public network (e.g., the Internet) via a network adapter 20. As depicted, the network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, data archival storage systems, etc.

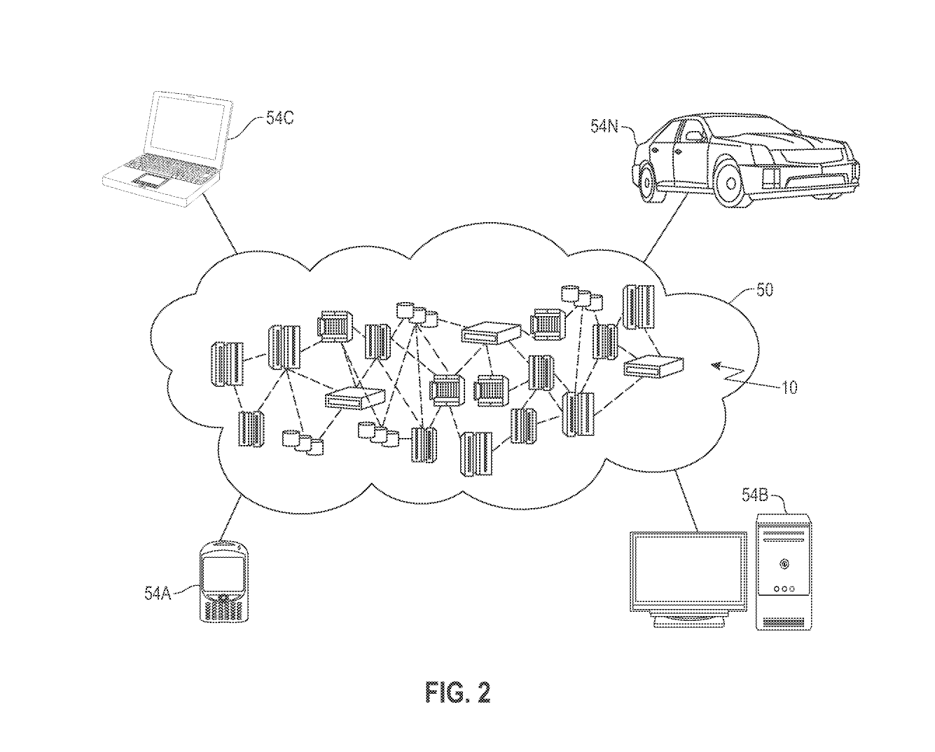

Referring now to FIG. 2, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

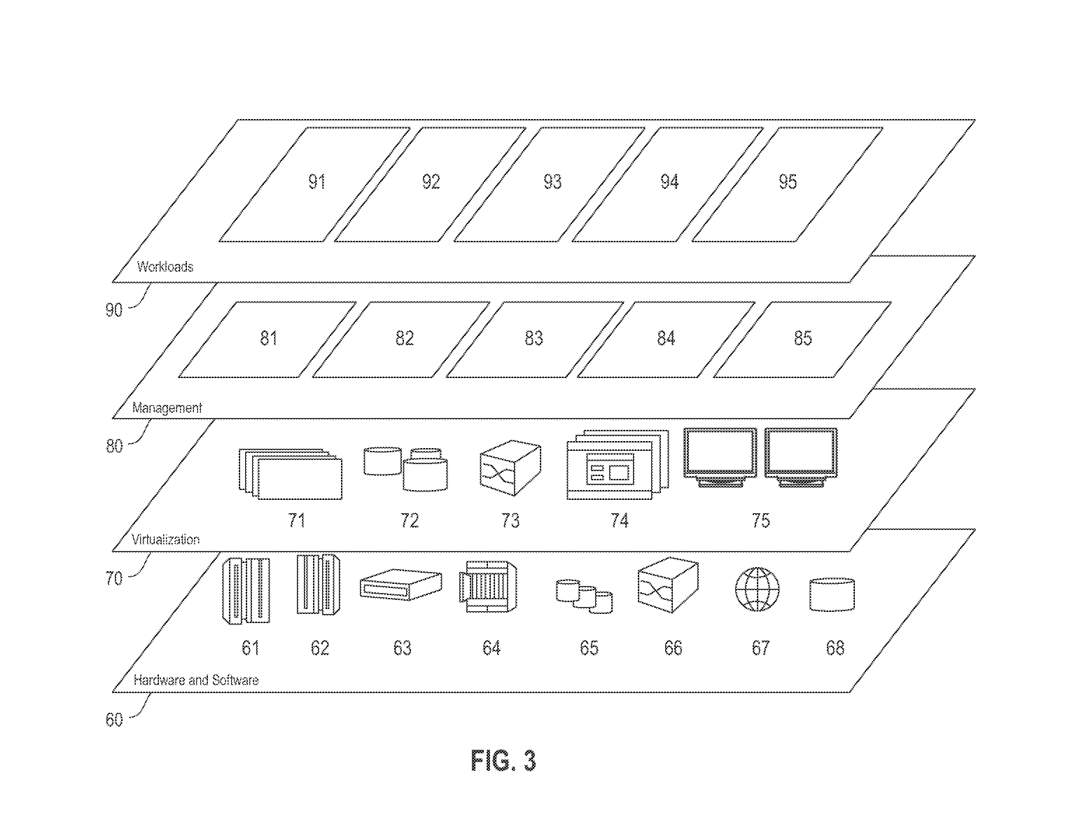

Referring now to FIG. 3, a set of functional abstraction layers provided by the cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95. As mentioned above, all of the foregoing examples described with respect to FIG. 3 are illustrative only, and the invention is not limited to these examples.

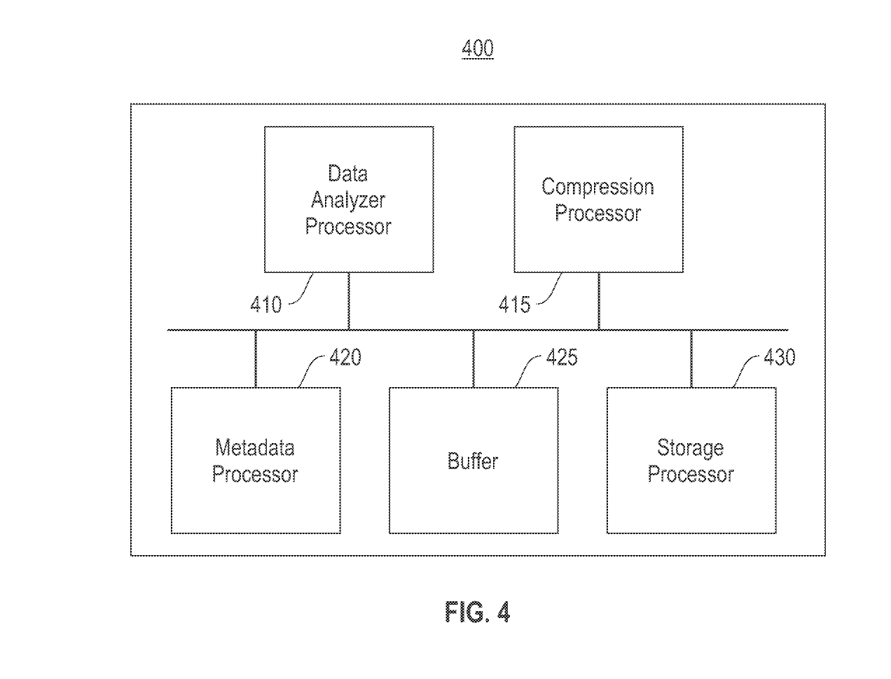

It is understood all functions of one or more embodiments as described herein may be typically performed by the processing system 12 (FIG. 1) or 400 (FIG. 4), which can be tangibly embodied as hardware processors and with modules of program code 42 of program/utility 40 (FIG. 1). However, this need not be the case. Rather, the functionality recited herein could be carried out/implemented and/or enabled by any of the layers 60, 70, 80 and 90 shown in FIG. 3.

It is reiterated that although this disclosure includes a detailed description on cloud computing, implementation of the teachings recited herein are not limited to a cloud computing environment. Rather, the embodiments of the present invention may be implemented with any type of clustered computing environment now known or later developed.

Embodiments of the invention relate to determining compressibility at the time that file data is resident in memory for efficient offline file data compression. One embodiment provided is a method that includes receiving a data file in a buffer. A processor detects that at least a portion of a data block of the data file resides in the buffer. A compressibility indication of the data block is determined based on performing at least one compressibility analysis operation on the data block. The compressibility indication of the data block is stored. A background compression task is performed on the data block, or an aggregated group of file blocks, based on: determining a compression decision for the data block based on the compressibility indication, or a compression decision for the aggregated group of file blocks, and compressing the data block or the aggregated group of file blocks, based on the compression decision. The compression decision may also be based on the compressibility of a group of aggregated data blocks calculated from the aggregated compressibility indication of these data blocks.

One or more embodiments provide determining and recording the compressibility of a data file while data still resides in the memory but on its way to be persisted on a memory device (e.g., a storage disk device). During this time period that the data resides in memory, light weight operations are performed on the data that provides an indication on the data compressibility, which makes offline compression more efficient. In one embodiment, results of the data analysis is recorded in the corresponding metadata or bit map and may then be used during an offline compression stage to achieve an optimal compression experience. For example, incompressible data should not be compressed at all. Identifying incompressible data while the data is inflight avoids reading the data again from disk in the offline compression phase. That is, the conventional compression techniques must read the data again from disk storage and, only then, can discover that the data is incompressible.

In one or more embodiments, the level of compressibility of a file is identified. In one example, the compressibility may be categorized into different levels of compressibility (e.g., extremely compressible, highly compressible, medium compressible and non-compressible). The scheduling of offline compression may then first target the most compressible data files, and reach the less beneficial files to compress only at a later stage, if at all. In one embodiment, compressing data offline based on level of compressibility is beneficial in a storage system with a limit on the compression resources. In one embodiment, the specific methods used for the analysis phase may vary and include, for example, one or more operations such as sampling, entropy estimation, etc.

In one or more embodiments, by performing compressibility analysis early while the data resides in a memory buffer prior to being moved to disk, system processing time is reduced, and overall system performance is improved since compressing changing data is avoided, optimal compression decision can be made after all file blocks within an aggregated group have been written and cooled down, incompressible data is skipped during a compression process, and the requirement to read data of a data file back into memory for compression is eliminated.

FIG. 4 is a block diagram illustrating a processing system 400 (e.g., a storage controller device, a multiprocessor, file system processor, etc.) for early determination of compressibility while file data resides in memory and for efficient offline file data compression. In one embodiment, the processing system 400 includes a data analyzer processor 410, a compression processor 415, a metadata processor 420, a buffer(s) 425 (e.g., a system buffer(s), a storage buffer(s), etc.) and a storage processor 430. In one embodiment, the processing system 400 is connected with one or more storage disk devices. In one example, processing system 400 may be included in or external to computing node 10.

A dirty buffer is a buffer that has been changed in memory but not yet written to disk. In one embodiment, data from a data file arrives (writes) dirtying a file block's in-memory buffer 425. In one embodiment, the data of the data file stays in the buffer 425 before being flushed to disk by the storage processor 430. The storage processor 430 detects that a whole block (or a significant portion of a block) of the data of a data file resides in the buffer 425. In one embodiment, the data analyzer processor 410 performs a compressibility analysis on the data block using one or more operations, such as sampling, entropy estimation, etc. on the data and determines compressibility. In one example, compressibility is determined by the data analyzer processor 410 based on comparing a result of the operations with one or more thresholds, which may be system-defined, user-configured, etc.

In one embodiment, the compressibility of the data block is recorded by the metadata processor 420. In one example, the compressibility is recorded the metadata processor 420 as a part of the data file's metadata (e.g., as a per-disk-block attribute, one or more bits in a disk address field of the data block, or a compressibility-bitmap attribute of the data file, etc). It should be noted that a disk may include memory devices, such as persistent memory devices (e.g., flash memory devices), etc. In one embodiment, the data of the data file is flushed to disk by the storage processor 430 after the data file metadata is recorded. The file metadata is also flushed to disk, including the compressibility bit in the disk address or a bitmap attribute.

In one embodiment, the compression processor 415 is responsible for performing offline compression on the data of the data file. In one embodiment, the compressor processor 415 may generate a task, a thread, a job, etc. for performing the offline compression. In one example, the compression processor 415 causes the storage processor 430 to open a file to be compressed. In one embodiment, the compression processor 415 retrieves the per-block compressibility information from the disk address field or a bitmap of the file metadata. The compression processor 415 determines whether a block is compressible (which may also be a per-block decision or an aggregated per-block group decision) based on the compressibility information. If the compression determination results in a decision to compress the data, the block or block group is read into the buffer 425, the compression processor 415 compresses the data using a selected data compression technique, and causes the storage processor 430 to write the compressed data back to disk. If the compression determination results in a decision to not compress the block or block group, the compression processor 415 skips reading/compressing the file data and skips to the next block or block group and proceeds again to obtain the next block or group of blocks compressibility information.

For different embodiments, the compressibility indicator may be different from a bit in the disk address field or a bitmap attribute. In one example embodiment, multiple bits may be used per block of file data to indicate the degree of compressibility (e.g., different levels of compressibility, such as low, medium, high, extremely high, incompressible, etc.). In this example embodiment, the compressibility decision is not a binary decision and provides for compression to be applied to blocks of varying degrees of compressibility, depending on how busy the system is and how much storage pressure the file system may be under. In one embodiment, the compressibility indicator may also be assigned to different data granularity, such as a multi-block group, or at a sub-block level.

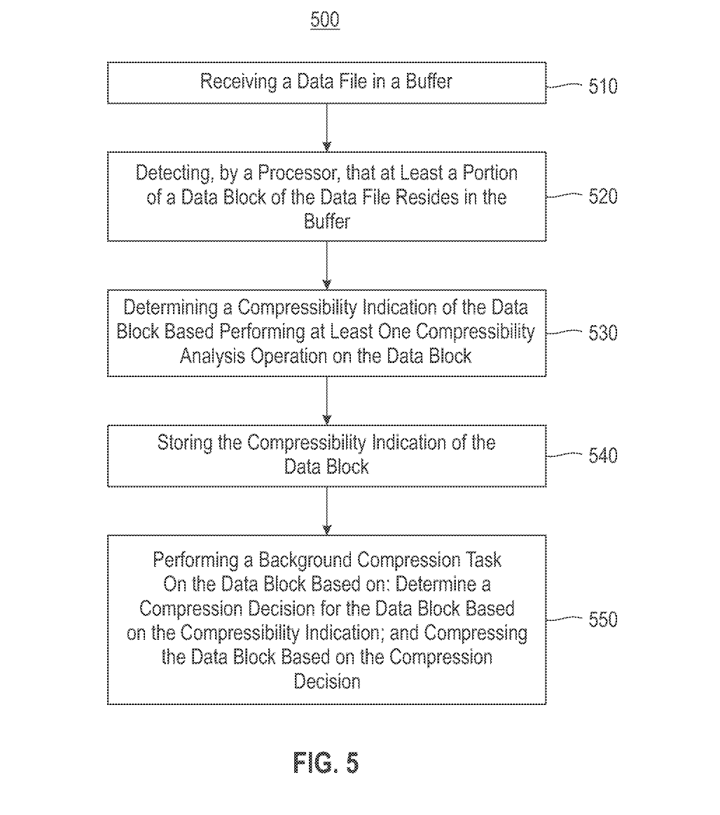

FIG. 5 illustrates a block diagram for a process 500 for determining compressibility while file data resides in memory and offline file data compression, according to one embodiment. In one embodiment, in block 510 a data file is received in a buffer (e.g., a buffer(s) 425, FIG. 4). In block 520 a processor (e.g., the storage processor 430, FIG. 4) detects that at least a portion of a data block of the data file resides in the buffer. In block 530 a compressibility indication of the data block is determined (e.g., by the data analyzer processor 410, FIG. 4) based on performing at least one operation on the data block. In block 540 the compressibility indication of the data block is stored (e.g., by the metadata processor 420, FIG. 4). In block 550 a background compression task is performed (e.g., by the compression processor 415, FIG. 4) on the data block based on: determining a compression decision for the data block based on the compressibility indication, and compressing the data block based on the compression decision.

When the compressibility analysis was not completed when the data block was written, process 500 may provide that receiving the data file includes writing the data file and dirtying the data block as in-memory in the buffer, or reading the data file and filling the data block as in-memory in the buffer. This is possible if the compressibility analysis is omitted when the system is overloaded and the data analyzer processor 410 (FIG. 4) does not get a chance to perform the analysis before the dirty data block is evicted from the memory buffer. In such case, the data analyzer processor 410 can perform the compressibility analysis next time when the data block is read into memory buffer due to a file read. In one embodiment, process 500 may provide using the compressibility analysis to select a compression technique from multiple compression techniques or to skip compression of the data block.

In one embodiment, process 500 may provide that the at least one operation includes a sampling operation or an entropy estimation operation. In one embodiment, process 500 may include that the compressibility indication is determined by comparing a result of the at least one operation to a system-defined threshold or a predetermined threshold.

In one embodiment, process 500 may provide that the compressibility indication is determined by categorizing the compressibility indication into a particular level of compressibility, and the background compression task performs compression in an order based on level of compressibility. In one embodiment, the compressibility indication is stored in metadata associated with the data block. In one embodiment, the compressibility indication is stored in the metadata based on one or more bits in a disk address field of the data block, or within a compressibility-bitmap attribute of the data file. In one embodiment, process 500 may include that after the compressibility indication is determined, the data file and the metadata is flushed to a memory device (e.g., a disk device).

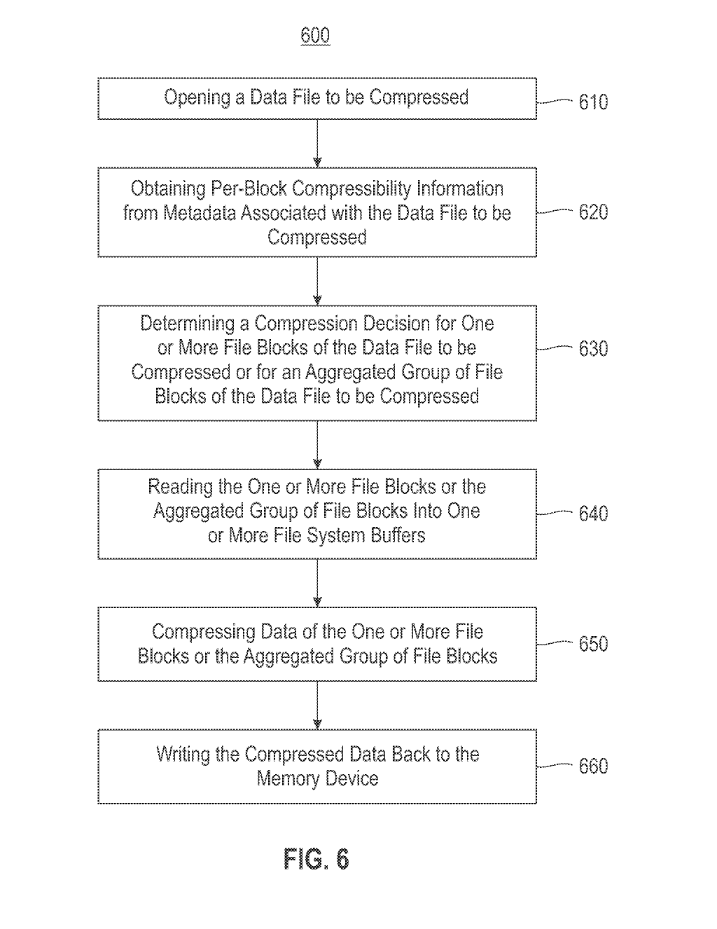

FIG. 6 illustrates a block diagram for a process 600 for offline compression, according to one embodiment. In one embodiment, in block 610 a data file to be compressed is opened. In block 620 per-block compressibility information is obtained from stored metadata that is associated with the data file to be compressed. In block 630 a compression decision for one or more file blocks of the data file to be compressed or for an aggregated group of file blocks of the data file to be compressed is determined. In block 640 the one or more file blocks or the aggregated group of file blocks are read into one or more file system buffers. In block 650 data of the one or more file blocks or the aggregated group of file blocks is compressed using a selected compression technique (e.g., predetermined, determined by the storage system requirements, etc.). In block 660 the compressed data is written back to the memory device (e.g., the disk device).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving a data file in a buffer;
detecting, by a processor, that at least a portion of a data block of the data file resides in the buffer;
determining a compressibility indication of the data block based on performing at least one compressibility analysis operation on the data block;
storing the compressibility indication of the data block; and
performing a background compression task on the data block based on:
determine a compression decision for the data block based on the compressibility indication; and
compressing the data block based on the compression decision.

2. The method of claim 1, wherein receiving the data file comprises writing the data file and dirtying the data block as in-memory in the buffer, or reading the data file and filling the data block as in-memory in the buffer.

3. The method of claim 1, wherein the at least one compressibility analysis operation is configured to select a compression technique from a plurality of compression techniques or to skip compression of the data block.

4. The method of claim 1, wherein a compressibility analysis operation is performed on a data block only if such operation has not been performed on this block since its last update.

5. The method of claim 1, wherein the at least one operation comprises a sampling operation or an entropy estimation operation, and the compressibility indication is determined by comparing a result of the at least one operation to a system-defined threshold or a predetermined threshold.

6. The method of claim 1, wherein the compressibility indication is determined by categorizing the compressibility indication into a particular level of compressibility, the background compression task performs compression in an order based on level of compressibility, and the compressibility indication is stored in metadata associated with the data block.

7. The method of claim 1, wherein the compressibility indication is stored in the metadata based on one or more bits in a memory address field of the data block, or within a compressibility-bitmap attribute of the data file, and after the compressibility indication is determined, the data file and the metadata is flushed to a memory device.

8. The method of claim 7, wherein performing the background compression task further comprises:
opening a data file to be compressed;
obtaining per-block compressibility information from metadata associated with the data file to be compressed;
determining a compression decision for one or more file blocks of the data file to be compressed or for an aggregated group of file blocks of the data file to be compressed;
reading the one or more file blocks or the aggregated group of file blocks into one or more file system buffers;
compressing data of the one or more file blocks or the aggregated group of file blocks; and
writing the compressed data back to the memory device.

9. A computer program product for early compression related processing in a file system with offline compression, the computer program product comprising a computer readable storage medium having program instructions embodied therewith, the program instructions executable by a processor to cause the processor to:
obtain, by the processor, a data file in a buffer;
detect, by the processor, that at least a portion of a data block of the data file resides in the buffer;
determine, by the processor, a compressibility indication of the data block based on performing at least one compressibility analysis operation on the data block;
store, by the processor, the compressibility indication of the data block; and
perform, by the processor, a background compression task on the data block based on:
determining, by the processor, a compression decision for the data block based on the compressibility indication; and
compressing, by the processor, the data block based on the compression decision.

10. The computer program product of claim 9, wherein the processor obtains the data file by reading the data file and filling the data block as in-memory in the buffer, or writing the data file and dirtying the data block as in-memory in the buffer.

11. The computer program product of claim 9, wherein the at least one compressibility analysis operation is configured to select a compression technique from a plurality of compression techniques or to skip compression of the data block.

12. The computer program product of claim 11, wherein the compressibility indication is determined by the processor comparing a result of the at least one operation to a system-defined threshold or a predetermined threshold.

13. The computer program product of claim 9, wherein the compressibility indication is determined by the processor categorizing the compressibility indication into a particular level of compressibility, and the background compression task performs compression in an order based on level of compressibility.

14. The computer program product of claim 9, wherein the compressibility indication is stored in metadata of the data block, one or more bits in a memory address field of the data block, or within a compressibility-bitmap attribute of the data file, and after the compressibility indication is determined, the data file and the metadata is flushed to a memory device.

15. The computer program product of claim 14, wherein the background compression task further comprises program instructions executable by the processor to cause the processor to:
open, by the processor, a data file to be compressed;
obtain, by the processor, per-block compressibility information from metadata associated with the data file to be compressed;
determine, by the processor, a compression decision for one or more file blocks of the data file to be compressed or for an aggregated group of file blocks of the data file to be compressed;
read, by the processor, the one or more file blocks or the aggregated group of file blocks into one or more file system buffers;
compress, by the processor, data of the one or more file blocks or the aggregated group of file blocks; and
write, by the processor, the compressed data back to the memory device.

16. An apparatus comprising:
a buffer configured to store a data file;
a data analyzer processor configured to detect that at least a portion of a data block of the data file resides in the buffer, and to determine a compressibility indication of the data block based on performing at least one compressibility analysis operation on the data block;
a metadata processor configured to store the compressibility indication of the data block; and
a compression processor configured to perform a background compression task on the data block based on being configured to:
determine a compression decision for the data block based on the compressibility indication; and
compress the data block based on the compression decision.

17. The apparatus of claim 16, wherein the at least one operation comprises a sampling operation or an entropy estimation operation, and the data analyzer processor is configured to determine the compressibility indication by being configured to compare a result of the at least one operation to a system-defined threshold or a predetermined threshold.

18. The apparatus of claim 16, wherein the data analyzer processor is configured to determine the compressibility indication by being configured to categorize the compressibility indication into a particular level of compressibility, the compression processor is configured to perform compression in an order based on level of compressibility, the compressibility indication is stored in the metadata of the data block, one or more bits in a memory address field of the data block, or within a compressibility-bitmap attribute of the data file, and a storage processor is configured to flush the data file and the metadata to a memory device.

19. The apparatus of claim 18, wherein the compression processor is configured to:
open a data file to be compressed;
obtain per-block compressibility information from metadata associated with the data file to be compressed;
determine a compression decision for one or more file blocks of the data file to be compressed or for an aggregated group of file blocks of the data file to be compressed;
cause the storage processor to read the one or more file blocks or the aggregated group of file blocks into one or more file system buffers;
compress data of the one or more file blocks or the aggregated group of file blocks; and
cause the storage processor to write the compressed data back to the memory device.

20. The apparatus of claim 19, wherein the compression processor is configured to open the data file by one of: writing the data file and dirtying the data block as in-memory in the buffer, or reading the data file and filling the data block as in-memory in the buffer, and to select a compression technique from a plurality of compression techniques or to skip compression of the data block.
